(19) United States
(12) Patent Application Publication
(10) Pub. No.: US 2006/0073239 A1
(43) Pub. Date: Apr. 6, 2006

(54) Filled pastry

(76) Inventors: Janet L. Boyle, St. Paul, MN (US); Carolina M. Hoxie, Plymouth, MN (US); Thomas J. Fort, Plymouth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/957,411

(22) Filed: Oct. 1, 2004

(51) Int. Cl. A23L 1/00

(52) U.S. Cl. 426/89

(57) ABSTRACT

A filled pastry having a cooked dough shell and a filling. The cooked dough shell is made from raw dough that includes whole-wheat flour, wheat bran, sweetener, shortening, and water and can have an appearance and flavor that is similar to graham crackers. The filling is prepared from a material that is distinct from the dough shell. The filling is substantially retained within the dough shell. An interface between the dough shell and the filling minimizes moisture migration.

### FIELD OF THE INVENTION

The invention relates generally to pastry products. More particularly, the invention relates to filled pastries that are particularly suited for heating in a toaster.

### BACKGROUND OF THE INVENTION

Filled pastries typically contain a dough component in which a filling is placed. A challenge relating to the development of filled pastries is retaining the desired appearance, texture and flavor while the filled pastries are stored and heated for consumption. Another challenge relating to filled pastries is that the filled pastries must have sufficient structural rigidity to facilitate heating the filled pastries often times in a vertical orientation using a conventional toaster.

It has been suggested to form the filled pastry with a large quantity of filling and a minimal surface contact between the dough and the filling. While such a configuration enhances the flavor impact for consumers, it sometimes reduces the stability of the filled pastry.

The interface between the dough and the filling is a source of various interactions such as moisture migration from the filling to the dough that causes the dough to become soggy. Other potentially undesirable results of dough-filling instability include dough and filling flavor loss and decrease of product structural integrity.

It has been attempted to overcome the preceding instability issues by reducing the moisture content of the filled pastries. For example, some filled pastries have been formed with a filling moisture content of between 15 and 20 percent by weight, and a dough moisture content of between 8 and 12 percent by weight. While using the preceding low moisture contents enhances the storage stability of the filled pastries, the taste and flavor of the filled pastries is also decreased.

It has been attempted to overcome the preceding limitations by altering the formulation of the filling. For example, Wallin et al., U.S. Pat. Nos. 4,612,198 and 4,623,542, both describe forming the filling with specified viscosity, pH and moisture content to provide a stable interface between the filling and dough.

### SUMMARY OF THE INVENTION

Embodiments of the invention are directed to a filled pastry with high moisture content that is particularly suitable for toasting and contains whole-wheat flour and wheat bran. The filled pastry includes a dough shell and a filling. The dough shell can be formed from whole-wheat flour, wheat bran, and water. The dough shell has a flaky exterior surface and can have a bready well-developed interior cell structure.

Wheat flour can be used at a concentration of about 0.1 to about 70 percent by weight. Wheat bran can be used at a concentration of about 0.1 to about 3 percent by weight. Water can be provided at a concentration of about 30 to about 50 percent by weight.

The filling is prepared from a material that is distinct from the dough shell, i.e., generally non-farinaceous. The filling is substantially retained within the dough shell. An interface between the dough shell and the filling minimizes moisture migration.

### DETAILED DESCRIPTION

The invention is directed to a filled pastry that is prepared from a dough shell and a filling where the dough shell contains wheat flour and/or wheat bran. In certain embodiments, the filled pastry of the invention can exhibit an appearance and a taste that are similar to graham crackers. The filled pastry of the invention can exhibit excellent performance during storage and reheating such that the filled pastry exhibits a flaky crust while the filling retains its desired characteristics, as is discussed in more detail below. The invention is thereby the first product that combines desirable appearance of a graham cracker-like dough shell in a filled, frozen pastry having a flaky shell after reheating.

The term “structural integrity,” as used herein, refers to a product that can be easily handled and prepared by the consumer without breaking apart because of such things as dough seams and the like. The term “product quality” refers to the combination of conditions that a consumer typically perceives as high quality for bakery-made pastries such as tender, flaky and crisp pastry surface, tender and moist interior, higher moisture level to obtain both a desirable mouthfeel and a higher flavor impact, uniformity of exterior surface browning, uniformity of interior filling color and freshness and not soggy. The term “well-developed” means that the gluten network in the dough shell has been formed to provide a cell structure, which holds air.

There is a unique problem with filled products that are to be fried, frozen, packaged, and shipped, as distinguished from filled products made fresh in a bakery and immediately sold, such as jelly donuts and bismarks. The latter type of products is less concerned with product stability because they are generally consumed or discarded in a very short time, such as less than a day. As such, the bakery-made products are generally not intended to have a long shelf life. Bakery-made products also may not need to have to undergo freezing, storage and reheating.

High moisture level is desirable in pastries because consumers perceive this feature upon tasting the product as part of the initial flavor impact as well as in part as a desirable mouthfeel. Typically, a filled bakery product such as a fresh made jelly donut will have a filling with a moisture content of between 40 and 60 percent by weight. A drawback of using moisture content in this range is that it encourages moisture migration. Moisture migration is a factor that contributes to decreases in the product quality of filled pastries. Moisture migration can cause sogginess in the dough, change the pastry texture and quality, and increases the risk of structural integrity failure.

Dough made according to this invention has a moisture content of about 20 percent to about 50 percent as well as about 28 percent to about 34 percent. The toaster pastry made according to this invention has a moisture content of about 20 percent to about 50 percent as well as about 25 percent to about 32 percent.

The filling typically comprises sweeteners, water, viscofiers, flavors and when appropriate acidulants and their salts. A wide variety of jelly or filling compositions and flavors having low moisture migration can be used in the invention. Examples of other fillings include meat, dairy, egg, tomato-based sauces, peanut butter, and combinations thereof.

In an embodiment of the invention, a dough shell can be prepared to have an appearance and taste that are similar to graham crackers, and a filling that includes chocolate and marshmallows. This formulation can provide a filled pastry with a taste that is similar to smores.

There is no specific limitation on many of the ingredients of the filling composition. Each of the ingredients is used to develop a desired sweetness-tartness combination as well as to provide a specific flavor such as grape, strawberry, cinnamon, cherry, and blueberry. One suitable filling formulation that can be utilized in the pastry industry is set forth in Table 1.

TABLE 1

| Ingredient | % by Weight |
|---|---|
| Sugar | 15-20% |
| Water | 40-70% |
| Fruit | 5-10% |
| Corn syrup | 5-10% |
| Artificial flavoring | 1-2% |
| Coloring | <0.25% |
| Modified starches | 2-3% |
| Preservatives | <1% |
| Gum | <0.1% |

Typical interactions between the filling and the dough shell can be minimized and brought into equilibrium such that there is good product quality and stability. Controlling both the viscosity and the pH of the filling composition by employing a pH buffering system provides such equilibrium.

It has been found that a filling of the invention, in combination with a wheat bran containing dough composition of the invention, can achieve a product of both high product quality and high moisture content, and yet one of good shelf stability and product stability. This can be advantageous at the interface between the filling and the interior surface of the dough shell.

Filling compositions according to embodiments of the invention can be stable, and in spite of high moisture content, does not detract from product quality, appearance or flavor, even during frying, freezing, and subsequent thawing and toasting such as described in more detail in Wallin et al., U.S. Pat. No. 4,612,198, which is incorporated herein by reference and which is commonly assigned.

The dough shell is prepared from a raw dough that can include white flour, whole-wheat flour, wheat bran, sweeteners, fat and water. White flour can be added to the dough formulation at a concentration of up to about 60 percent by weight of the dough formulation. In certain embodiments of the invention, white flour can be about 45 to about 60 percent by weight of the dough formulation. White flour used in conjunction with certain embodiments of the invention is hard wheat enriched flour.

Whole-wheat flour is present in the dough formulation at a concentration of up to about 70 percent by weight of the dough formulation. In certain embodiments of the invention, whole-wheat flour can be about 2 to about 15 percent by weight of the dough formulation as well as about 10 percent by weight of the dough formulation.

Wheat bran is present in the dough formulation at a concentration of about 0.5 to about 5 percent by weight of the dough formulation. In certain embodiments of the invention, wheat bran can be about 1 to about 3 percent by weight of the dough formulation.

The sweetener concentration can be up to about 22 by weight of the dough formulation depending on the desired sweetness of the filled pastry. In embodiments of the invention, sweetener concentration can be about 4 to about 15 percent by weight of the dough formulation as well as about 10 percent by weight of the dough formulation.

Sweeteners suitable for the invention, include, for example, refiner's syrup, sucrose, sucralose, nutritive and non-nutritive sweeteners (such as acesulfame K and aspartame), molasses, corn syrups, high fructose corn syrups, corn syrup solids, honey, maple syrup, dextrose, sorbitol, other sugar alcohols and combinations thereof.

The dough formulation can also include fat, which can be added in a variety of formats such as chips, liquids and solids. The fat can also be provided as a roll-in shortening as discussed in more detail below. A dough fat can be added at a concentration of up to about 15 percent by weight of the dough formulation. In certain embodiments of the invention, dough fat can be about 2 to about 4 percent by weight of the dough formulation.

Water in the dough formulation can be at a concentration of about 30 to 50 percent by weight of the dough formulation. In embodiments of the invention, water concentration can be about 34 to about 36 percent by weight of dough formulation.

The dough formulation of the invention is generally a leavened dough, although non-leavened dough is within the scope of the invention. A leavened dough can be organically leavened (e.g. yeast), chemically leavened or a combination of both.

When a yeast is used, it may be typical baker's dry yeast, and can be at a concentration of about 0.5 to about 3 percent by weight of the raw dough formulation. In certain embodiments of the invention, yeast can be about 1 to about 3 percent by weight of the dough formulation, as well as about 1.0 to about 1.8 percent by weight of the dough formulation. Yeast can be used for leavening, as well as a flavor enhancer to provide better taste.

Chemical leaveners, i.e., systems with chemical leavening acids and bases, may also be used in preparing the dough product of the invention. The chemical leavening system used in preparing the dough products of the invention may include at least one chemical leavening base. Any chemical leavening base that is capable of undergoing the reaction is suitable for use in the dough product of the invention.

Although a base may be included to react with each chemical leavening acid, i.e., more than one base may be utilized, in an embodiment, the chemical leavening base would be capable of reacting with both of the at least two chemical leavening acids. Such chemical leavening bases are well known to those of skill in the art and, as a result, only the exemplary chemical leavening bases, sodium bicarbonate (baking soda), ammonium bicarbonate and potassium bicarbonate, are recited herein.

The chemical leavening system utilized in the dough products of the invention further may include at least two chemical leavening acids that may be classified as fast acting or slow acting. Suitable fast acting chemical leavening acids for use in the dough products of the invention include, but are not limited to, any of the sodium acid pyrophosphates (SAPP), monocalcium phosphate monohydrate (MCP), sodium aluminum sulfate (SAS), glucono delta lactone (GDL), potassium hydrogen tartrate (cream of tartar), combinations of these and the like.

Suitable slow acting chemical leavening acids include those that have a relatively lower solubility in water and require higher temperatures to react with chemical leavening bases. Consequently, slow acting chemical leavening acids typically react with a chemical leavening base later in the cooking cycle. Slow acting chemical leavening acids that are suitable for use in the dough products of the invention include, but are not limited to, sodium aluminum phosphate (SALP) and dicalcium phosphate (DCP).

In an embodiment of the invention, bicarbonate of soda is used in the dough formulation at a concentration of up to about 0.5 percent by weight of the dough formulation. In embodiments of the invention bicarbonate of soda can be powdered and used at a concentration of about 0.2 to about 0.3 percent by weight of the dough formulation.

In an embodiment of the invention, sodium acid pyrophosphate (SAPP) is used in the dough formulation at a concentration of up to about 0.5 percent by weight of the dough formulation. In embodiments of the invention, SAPP can be at a concentration of about 0.2 to about 0.3 percent by weight of the dough formulation.

Optionally, salt can be in a dough formulation at a concentration of about 0.5 to about 2 percent by weight of the dough formulation. In embodiments of the invention, salt concentration is about 1 to about 1.5 percent by weight of the dough formulation.

Emulsifying agents, such as mono- and di-glyceride emulsifiers, are well known to those in the art. The emulsifying agents, when desired, can be used at a concentration of up to about 5 percent by weight of the dough formulation. In embodiments of the invention, the emulsifying agent concentration can be about 0.1 to about 3.3 percent by weight of the dough formulation, as well as about 0.1 percent by weight of the dough formulation.

Optionally, eggs can be included in the dough formulation. The eggs can be used in the form of whole egg solids at a concentration of about 0.5 to about 3.0 percent by weight of the dough formulation. In embodiments of the invention whole egg solids can be at a concentration of about 1.5 to about 2.0 percent by weight of the dough formulation. Egg yolk solids can also be used at a concentration of about 0.5 to about 3.0 percent by weight of the dough formulation as well as about 0.85 percent by weight of the dough formulation.

According to a process of the invention, during the preparation of the dough formulation, the dry components can be mixed together prior to the addition of water and the leavening system. The water and leaveners can be added to the dough formulation at a controlled temperature to prevent premature proofing. The mixer can have a cooling jacket to assure that the temperature is low enough to prevent premature proofing. In other embodiments of the invention, water can be used in the form of ice.

During the initial mixing, the dough temperature can be maintained at a temperature of about 66° F. or less, as higher temperatures may result in poor sheeting characteristics and may result in premature proofing. Mixing is performed for about 3 to about 30 minutes, and can be about 4 to about 10 minutes depending on the quantity of ingredients used.

A dough can be prepared in a two-stage process. Depending on the speed of the mixer and ingredient quantities, the first mixing stage may be done for up to about 10 minutes as well as from about 6 minutes to about 8 minutes. The second mixing stage may be done for up to about 10 minutes as well as from about 2 minutes to about 3 minutes.

The dough shell according to exemplary embodiments of the invention can be a laminated pad that includes alternating laminations of dough and roll-in shortening. After the dough is prepared (e.g., sheeted), it is then coated with a hydrated or anhydrous roll-in shortening. The roll-in shortening can be at a concentration of about 4 to about 22 percent by weight of a laminated dough pad. In embodiments of the invention, the roll-in shortening can be about 5 to about 11 percent by weight of a laminated dough pad, as well as about 6 to about 7 percent by weight of a laminated dough pad.

Shortening for use as a roll-in in the product may be any of conventional hydrogenated vegetable oil shortenings that are commonly employed in the baking industry. Plastic or hydrogenated glyceride shortenings derived most commonly from vegetable oils by hydrogenation are useful. Suitable oils include but are not limited to cottonseed oil, soybean oil, rapeseed oil, peanut oil, olive oil, palm oil, sunflower oil and the like. It is possible to use the roll-in shortening in a variety of forms such as chips, flakes, liquid or sheets.

Rolling in of the shortening can be accomplished using conventionally known equipment during a sheeting step in which alternating layers of dough and shortening placed upon each other. One such suitable machine is a Rondo sheeter (Rondo Inc., Moonachie, N.J.). To achieve the desired results of a laminated format for exemplary embodiments of the invention, substantially discrete and continuous shortening layers are prepared between the layers of dough. In embodiments of the invention, there are from about 2 to 36 substantially discrete and continuous layers of dough as well as from about 6 to 12 layers of dough. However, laminate doughs can comprise much greater number of layers, even up to 100 or more.

When a laminated dough pad such as that described herein is utilized, in combination with the dough formulation and the filling formulation described herein, the result is a high quality filled pastry with high structural integrity that is generally degradation resistant during frying, freezing, thawing, refrigeration and toasting.

In embodiments of the invention, the laminated dough pad has a thickness of about two millimeters or less. With such pad dimensions, the product, after expansion during cooking, will still easily fit within a conventional toaster, toaster oven or microwave. In the case of a toaster, the product, even after expansion during toasting, can still be easily removed from the toaster without damage.

If shortening layers are broken or are not discrete, product stability may be hindered whereby increased moisture migration may occur. The product may have a tendency to be somewhat soggier if the shortening layers are broken or are not discrete. Thus, the shortening layers are applied so that they are discrete and non-broken.

It has also been found that the dough of this invention reduces migration of moisture from filling to dough compared to conventional non-laminated doughs such as used for donuts and bismarks. Also, the laminated dough pad resists delamination on its exterior surface, and at the same time exhibits a well-developed bready interior cell structure that is stable at its most interior surface with respect to the area of contact with the filling.

After the laminated dough pad is made, the laminated dough pad is filled and folded to form an encasing shell. This process can be referred to as “make up.” The make up process may vary but it generally includes dedusting the laminated dough pad. This step can comprise brushing off excess flour from the pad surface such as with rotating brush dedusters.

After dedusting, the laminated dough pad may be docked, followed by slitting to a desired width, and depositing, such as volumetric deposition, of the filling. In embodiments of the invention, the filling can be at a temperature of about 35° F. to about 80° F. as well as about 65° F. to about 75° F. when deposited. A water spray can be applied along the edges of the sheet such that good effective sealing and seam integrity are achieved.

The folders and crimpers used in the baking industry are well known. With respect to the product of the type described herein, the laminated dough pad is folded upon itself, laying down the top dough layer after depositing the filling on the bottom dough layer. Folding can be accomplished manually or using mechanical implements such as a dough plow.

Free edges of the product can be finished by, for example, crimping. The folded edge can be crimped to provide all edges with a similar appearance. After crimping, a laminated dough pad having a plurality (e.g., 6 to 12) discrete and continuous layers, which completely surrounds the filling, is formed.

It has been found desirable to reduce the thickness of the laminated dough pad thickness less than a 50 percent during each pass through the rollers. Attempting to achieve a greater than 50 percent reduction in laminated dough pad thickness per pass, decreases the ability to obtain discrete and continuous layers in the laminated dough pad. Also, the dedusting technique discussed above removes excess flour that might cling to the laminated dough pad and interact with the filling on the inner surface of the dough pad.

Proofing the dough is conducted for a sufficient time to allow a volume increase. This can be done for about 20 to about 40 minutes, as well as about 20 to about 30 minutes, at conventional proofing conditions such as temperatures of about 105° F. to about 110° F. and at a relative humidity of about 66 to about 70 percent. During proofing the product can expand in volume as much as about 80 percent, with the laminated dough pad itself expanding in volume as much as about 100 percent. After proofing, the product is ready for cooking, such as by frying or baking.

Constraint on the product can be utilized during cooking to assure that in embodiments intended for heating in a conventional toaster. In such cases a constraint assures that the filled pastry will not expand to a thickness beyond which it will no longer fit within a toaster. For automated processes, the cooking can be done in a double restraint cooker. The filled pastry is restrained as it passes into the cooker by a lower conveyor screen upon which the filled pastry rests and is also at least partially constrained by an upper conveyor screen. During about the first quarter period of cooking, the product can ride wholly on the lower conveying screen without any upper constraint. Thereafter, as the product moves through the cooker (e.g., fryer), the filled pastry becomes constrained with respect to both the upper conveying screen as well as the lower conveying screen.

Cooking conditions are set to achieve a crisp surface and a moist but not gummy interior. Typically, these results can be achieved by frying at a temperature of about 350° F. to about 425° F. for about 25 to about 180 seconds. In embodiments of the invention, cooking is at a temperature of about 360° F. to about 380° F. for about 40 to about 50 seconds, as well as about 375° F. for about 37 to about 43 seconds. Numerous frying oils may be used for frying the filled pastry. One suitable oil is Durkee's Durkex 100 (Loders Croklaan BV, Wormerveer, Netherlands).

For embodiments intended for heating or toasting in a conventional toaster, the product is conveyed so that immediately after cooking, as the product exits from the cooker, the gap between the constrained conveying screens is slightly decreased to provide a post-cooking thickness of about 15 to about 20 millimeters. Such a size is especially suitable for placing in a conventional toaster.

After frying, the product can then be frozen and packaged. To enhance the shelf life of the filled pastry, the filled pastry is frozen during distribution and storage prior to consumption. As an alternative to heating the filled pastry in a conventional toaster, it is also possible to heat the filled pastry in other devices such as a microwave oven or a conventional oven.

The filled pastry can be provided in a pastry kit that also includes a topping composition. The topping composition can be prepared from a variety of materials such as diary-based ingredients, icing, fruit, meat, tomato-based sauces, peanut butter, decorative sprinkles, and combinations thereof.

The dough shell and the filling can each have a substantially similar water activity. The filling has a water activity that allows the filling to act as a moisture sink to absorb moisture from the dough shell during frying, without the subsequent return of that moisture to the dough shell during heating and storage. In embodiments of the invention, the dough shell and the filling each have a water activity of about 0.80 to about 1.00. In one exemplary embodiment of the invention, the dough shell has a water activity of about 0.89 and the filling has a water activity of about 0.83.

The above description has been set forth with respect to the use of laminated dough pads for the preparation of the filled pastry. A person of ordinary skill in the art will appreciate that the concepts of the invention are suitable for other applications such as using blitzed dough. In this method, marble-sized chunks of shortening are mixed into the dough to obtain improvements in texture. This same general technique is used when fat chips are introduced into the dough as discussed in Fehr, U.S. Pat. No. 3,582,353, which is hereby incorporated by reference.

When the filled pastry is prepared as described herein, it has been found during storage and stability testing, that the product does not exhibit any undesirable characteristics typical of product degradation at the interface of the dough and the filling. In particular, even though high moisture content is present in the filling, there is minimal moisture migration; there is no sogginess in the interior fried dough composition; and the exterior surface remains flaky, tender and crisp.

The filled pastry thereby exhibits all of those traditional consumer-preferred characteristics of fried or baked pastries. Advantageously, structural integrity is also preserved, with very little filling leakage exhibited. A filled pastry is also delamination resistant during subsequent toasting, and in certain formats, is of the proper thickness and dimensions such that it will easily fit within the conventional toaster.

The product and method of the invention are described in the following examples. These examples are provided as an illustration of the invention and are not intended to limit the invention.

### EXAMPLE 1

A high moisture mixed dough and laminated dough pad were prepared in the following manner. The white flour used was a moderately strong flour having a protein content of about 12.5 percent by weight of the dough formulation. A whole-wheat flour was used at about 10 percent by weight of the total flour.

The white flour and the whole-wheat flour were blended in a double stained blender for about two minutes, after which dough fat, sugar and salt were added and additional dry blending occurred. Thereafter, water and hydrated yeast were added and mixing continued to provide an initial mixed dough having a water content of about 54.5 percent. The total composition of the mixed dough, including all minor additives as set forth in Table 2.

TABLE 2

| Ingredient | Percent by Weight |
|---|---|
| Hard wheat enriched flour | 52.51 |
| Whole wheat flour | 5.5 |
| Wheat bran | 1.00 |
| Potable water | 35.51 |
| Light refiners syrup | 3.00 |
| Hydrogenated vegetable shortening | 2.50 |
| Sucrose (granulated) | 1.75 |
| Whole egg solids (salmonella free) | 1.70 |
| Active dry yeast | 1.50 |
| Salt (medium fine, unfilled) | 1.04 |
| Sodium acid pyrophosphate | 0.25 |
| Bicarbonate of Soda (powdered) | 0.25 |

After the mixed dough composition was prepared, a dough pad was formed involving discrete and continuous lamination of shortening and the above described mixed dough composition to provide a laminated dough pad having six shortening layers per millimeter of laminated dough pad thickness. In this instance, the total thickness of the laminated dough pad layer was about two millimeters.

The amount of roll-in shortening was about 6.5 percent by weight of the laminated dough pad preparation. The roll-in shortening was a hydrated, hydrogenated vegetable shortening. The shortening and the mixed dough composition were fed into a Rondo sheeter belt.

About 20 pounds of the mixed dough were transferred to lightly floured dusted Rondo belt, with dusting flour applied to its top surface. The mixed dough was sheeted and three-folded upon itself to form a continuous pad. Thereafter, a shortening sheet of the type earlier described was prepared having a width of 8½ inches and a length of 18 inches. The shortening sheet weighed approximately 340 grams.

The shortening was rolled-in by conventional techniques and the ultimate laminated dough pad having six continuous and discrete layers was sheeted down to a thickness of about two millimeters. Thereafter, the laminated dough pad having the rolled-in discrete and continuous shortening layers as described was fed to a make up table.

At the make up table, the surface flour on the laminated dough pad was removed by dedusters. The dedusters were two rotating brush dedusters that move over the top surface. The laminated dough pad was docked and thereafter (the laminated dough pad was about 20 inches wide), was slit into three sections of approximately uniform width.

The filling was applied to the laminated dough pad. A water spray was applied at each edge of the slit laminated dough pad to enhance dough-to-dough crimping.

Thereafter, the laminated dough pad was passed into a static plow that folded the laminated dough pad down the middle. The half section of the laminated dough pad with the filling stayed on the belt, while the other half rode up the plow and folded over on the filling. A longitudinal crimper then crimped all sides of the product to provide a product of uniform visual appearance. The width of the product after crimping was about 3 inches.

The product was next transferred to a proofer, where it was held for about 25 minutes, at a relative humidity of about 68 percent and a temperature of about 110° F. The filled pastry was then cooked using a double constraint fryer at a temperature of about 375° F. for about 37 to about 43 seconds. Even though the filled pastry is made from laminated and fried and conventional graham crackers are not laminated and baked, the filled pastry exhibited a color that is similar to conventional graham crackers.

It is contemplated that features disclosed in this application, as well as those described in the above applications incorporated by reference, can be mixed and matched to suit particular circumstances. Various other modifications and changes will be apparent to those of ordinary skill.

1. A filled pastry comprising:
a cooked dough shell made from a raw dough comprising flour, wheat bran, and water, wherein the raw dough contains flour selected from the group consisting of white flour, wheat flour and combinations thereof, wherein the flour is present at a concentration of about 0.1 to about 70 percent by weight, wheat bran at a concentration of about 0.1 to about 3 percent by weight, and water at a concentration of about 30 to about 50 percent by weight, wherein the cooked dough has a flaky exterior surface and a bready well-developed interior cell structure; and
a filling prepared from a material that is distinct from the cooked dough shell, wherein the filling is substantially retained within the dough shell, and wherein an interface between the dough shell and the filling minimizes moisture migration.

2. The filled pastry of claim 1, wherein the cooked dough shell has an appearance and texture that is similar to graham crackers.

3. The filled pastry of claim 1, wherein the cooked dough shell and the filling each have a water activity of about 0.80 to about 1.00.

4. The filled pastry of claim 1, wherein the white flour is at a concentration of about 45 to about 60 percent by weight.

5. The filled pastry of claim 4, wherein the white flour is a high protein flour.

6. The filled pastry of claim 1, wherein the raw dough contains whole wheat flour at a concentration of about 2 to about 7 percent by weight.

7. The filled pastry of claim 1, wherein the raw dough contains wheat bran at a concentration of about 1 to about 3 percent by weight.

8. The filled pastry of claim 1, wherein the raw dough further comprises sweetener at a concentration of up to about 10 percent by weight.

9. The filled pastry of claim 8, wherein the raw dough contains sweetener at a concentration of about 4 to about 6 percent by weight.

10. The filled pastry of claim 8, wherein the sweetener is refiner's syrup, sucrose, sucralose, nutritive and non-nutritive sweeteners, molasses, corn syrups, high fructose corn syrups, corn syrup solids, honey, maple syrup, dextrose, sorbitol, other sugar alcohols and combinations thereof.

11. The filled pastry of claim 1, wherein the raw dough further comprises fat at a concentration of up to about 15 percent by weight.

12. The filled pastry of claim 11, wherein the raw dough contains fat at a concentration of about 2 to about 4 percent by weight.

13. The filled pastry of claim 1, wherein the cooked dough shell further comprises a leavening system.

14. The filled pastry of claim 1, wherein the cooked dough shell has a laminated structure comprising a plurality of alternating dough and shortening layers.

15. The filled pastry of claim 14, wherein the shortening layers are fabricated from shortening chips, shortening flakes, a solid shortening, or combinations thereof.

16. The filled pastry of claim 1, wherein the filling comprises a material derived from tomato, chocolate, marshmallows, fruit, meat, dairy, egg, peanut butter, and combinations thereof.

17. The filled pastry of claim 16, wherein the filling comprises at least two discrete components.

18. The filled pastry of claim 1, wherein the filled pastry is frozen or refrigerated, and wherein the filled pastry, upon reheating, provides a moisture retained product.

19. A filled pastry comprising:
a raw dough shell made from a raw dough comprising flour, wheat bran, and water, wherein the raw dough contains flour selected from the group consisting of white flour, wheat flour and combinations thereof, wherein the flour is present at a concentration of about 0.1 to about 70 percent by weight, wheat bran at a concentration of about 0.1 to about 3 percent by weight, and water at a concentration of about 30 to about 50 percent by weight, wherein the raw dough has a flaky exterior surface and a bready well-developed interior cell structure; and
a filling prepared from a material that is distinct from the raw dough shell, wherein the filling is substantially retained within the dough shell, and wherein an interface between the dough shell and the filling minimizes moisture migration.

20. The filled pastry of claim 19, wherein the raw dough shell and the filling each have a water activity of about 0.80 to about 1.00.

21. The filled pastry of claim 19, wherein the raw dough contains whole wheat flour at a concentration of about 2 to about 7 percent by weight.

22. The filled pastry of claim 19, wherein the raw dough contains wheat bran at a concentration of about 1 to about 3 percent by weight.

23. The filled pastry of claim 19, wherein the raw dough contains sweetener at a concentration of about 4 to about 6 percent by weight.

24. The filled pastry of claim 19, wherein the raw dough contains fat at a concentration of about 2 to about 4 percent by weight.

25. A filled pastry comprising:
a cooked dough shell comprising:
a raw dough comprising white flour, whole wheat flour, wheat bran, sweetener, fat, and water, wherein the raw dough contains white flour at a concentration of about 45 to about 60 percent by weight, wheat flour at a concentration of about 0.1 to about 10 percent by weight, wheat bran at a concentration of about 0.1 to about 3 percent by weight, sweetener at a concentration of up to about 10 percent by weight, fat at a concentration of up to about 10 percent by weight, and water at a concentration of about 30 to about 50 percent by weight, wherein the cooked dough has a flaky exterior surface and a bready well-developed interior cell structure; and
a roll-in shortening, wherein the raw dough and the roll-in shortening are formed in a laminated structure having a plurality of alternating layers of raw dough and roll-in shortening; and
a filling prepared from a material that is distinct from the cooked dough shell, wherein the filling is substantially retained within the dough shell, and wherein an interface between the dough shell and the filling minimizes moisture migration.

26. The filled pastry of claim 25, wherein the cooked dough shell has an appearance and texture that is similar to graham crackers.

27. The filled pastry of claim 25, wherein the cooked dough shell and the filling each have a water activity of about 0.80 to about 1.00.

28. The filled pastry of claim 25, wherein the raw dough further comprises white flour at a concentration of about 45 to about 60 percent by weight.

29. The filled pastry of claim 25, wherein the raw dough contains wheat bran at a concentration of about 1 to about 3 percent by weight.

30. The filled pastry of claim 25, wherein the raw dough contains sweetener at a concentration of about 4 to about 6 percent by weight.

31. The filled pastry of claim 25, wherein the sweetener is refiner's syrup, sucrose, sucralose, nutritive and non-nutritive sweeteners, molasses, corn syrups, high fructose corn syrups, corn syrup solids, honey, maple syrup, dextrose, sorbitol, other sugar alcohols and combinations thereof.

32. The filled pastry of claim 25, wherein the raw dough contains fat at a concentration of about 2 to about 4 percent by weight.

33. The filled pastry of claim 25, wherein the cooked dough shell further comprises a leavening system.

34. The filled pastry of claim 25, wherein the roll-in shortening is in the form of shortening chips, shortening flakes, a solid shortening, or combinations thereof.

35. The filled pastry of claim 25, wherein the filling comprises a material derived from tomato, chocolate, marshmallows, fruit, meat, dairy, egg, peanut butter, and combinations thereof.

36. A pastry kit comprising:
a filled pastry comprising:
a cooked dough shell made from a raw dough comprising flour, wheat bran, sweetener, fat, and water, wherein the raw dough contains flour selected from the group consisting of white flour, wheat flour and combinations thereof at a concentration of about 0.1 to about 70 percent by weight, wheat bran at a concentration of about 0.1 to about 3 percent by weight, sweetener at a concentration of up to about 10 percent by weight, fat at a concentration of up to about 15 percent by weight, and water at a concentration of about 30 to about 50 percent by weight, wherein the cooked dough has a flaky exterior surface and a bready well-developed interior cell structure; and
a filling prepared from a material that is distinct from the cooked dough shell, wherein the filling is substantially retained within the cooked dough shell, and wherein an interface between the cooked dough shell and the filling minimizes moisture migration; and
a plurality of individually packaged containers containing a topping composition.

37. The pastry kit of claim 36, wherein the cooked dough has an appearance and texture that is similar to graham crackers.

38. The pastry kit of claim 36, wherein the cooked dough shell has a laminated structure comprising a plurality of alternating dough and shortening layers.

39. A method of preparing a cooked filled pastry that is suitable for heating in a toaster, the method comprising:
preparing a raw dough from flour, wheat bran, and water, wherein the raw dough contains flour selected from the group consisting of white flour, wheat flour and combinations thereof at a concentration of about 0.1 to about 70 percent by weight, wheat bran at a concentration of about 0.1 to about 3 percent by weight, and water at a concentration of about 30 to about 50 percent by weight
forming the raw dough into a dough shell;
placing a filling inside of the dough shell;
sealing the filling inside the raw dough so that the filling remains inside the dough shell during cooking; and
cooking the pastry, wherein the dough shell has a flaky exterior surface and a bready well-developed interior cell structure, wherein the filling is substantially retained within the dough shell, and wherein an interface between the dough shell and the filling minimizes moisture migration.

40. The method of claim 39, and further comprising freezing the pastry.

41. The method of claim 39, wherein forming the dough into a desired shape comprises forming the dough into sheets.

42. The method of claim 39, and further comprising preparing a laminated structure by stacking dough sheets and shortening layers in an alternating manner.
